(19) United States
(12) Patent Application Publication
(10) Pub. No.: US 2024/0382285 A1
(43) Pub. Date: Nov. 21, 2024

(54) DENTAL IMPLANT IRRIGATION

(71) Applicant: Irriguide, LLC, Barrington, IL (US)

(72) Inventors: Thomas F. Jackson, Barrington, IL (US); Ryan Jackson, Inverness, IL (US)

(73) Assignee: Irriguide, LLC, Barrington, IL (US)

(21) Appl. No.: 18/499,194

(22) Filed: Oct. 31, 2023

Related U.S. Application Data
(60) Provisional application No. 63/467,310, filed on May 17, 2023.

(51) Int. Cl. A61C 1/08; A61C 1/00

(52) U.S. Cl. CPC A61C 1/084; A61C 1/0061

(57) ABSTRACT

An irrigation guide for providing irrigation to the site of an osteotomy procedure. The irrigation guide includes an insertion end for insertion into an irrigation passage provided in a surgical template for guiding an osteotomy drill. The irrigation passage communicates with a guide chamber defined by the surgical template and surrounding the osteotomy site. The irrigation guide also includes a coupling end configured for connection with a source of irrigation fluid. The insertion end and the coupling end may be angled relative to one another. The insertion end of the irrigation guide may be inserted into and secured to the irrigation passage such that the irrigation guide provides a fluid communication pathway between the source of irrigation fluid and the guide chamber. The irrigation guide may be included in kits that include the surgical template and/or a drill bit configured to form the irrigation passage in the surgical template.

### CROSS-REFERENCE TO RELATED APPLICATION

This application claims the benefit of and priority to U.S. Provisional Patent Application No. 63/467,310, filed on May 17, 2023, the entire contents of which are hereby incorporated by reference herein.

### BACKGROUND

The present disclosure relates to apparatus and methods for providing irrigation during dental implant procedures.

The dental implant osteotomy process involves making incisions into a patient's gums to expose the underlying bone of the upper or lower jaw. One or more holes are then drilled into the bone such that dental implant posts can be inserted therein. In a successful dental implant osteotomy process, the bone surrounding the implant recovers and grows around the implant such that the implant becomes osseointegrated. Artificial dentures or other dental devices may then be secured to the implant.

It has been found that one key to successful dental implant surgery is maintaining the temperature of the bone, into which the implantation holes are being drilled, below 47 degrees Celsius. It is believed that temperatures in excess of 47 degrees C. for extended durations of time, e.g. more than approximately 1 minute, result in bone necrosis, which may prevent the bone from recovering and osseointegrating around the implant after the implant has been inserted into the hole.

### SUMMARY

In some aspects, a kit for irrigating a dental implant surgical template is provided, the surgical template may include a guide chamber adapted to receive a surgical drill, and the kit may comprise a drill bit including a cutting tip, a shank, and an interface profile between the tip and the shank. The tip may be configured to form an irrigation passage in the surgical template that communicates with the guide chamber, and the interface profile may be configured to form a first interface surface on the surgical template. An irrigation guide may include a second interface surface, a coupling end, and an irrigation channel extending between the second interface surface and the coupling end. The second interface surface may be engageable with the first interface surface to secure the irrigation guide to the first interface surface and to place the irrigation channel into fluid communication with the irrigation passage. The coupling end may be couplable to a source of irrigation fluid for providing irrigation fluid to the irrigation channel and the guide chamber.

The second interface surface may fit within the first interface surface to secure the irrigation guide to the first interface surface. The first interface surface may define a cylinder and the second interface surface may be tapered such that the second interface surface fits snugly within the cylinder when the second interface surface is inserted into the cylinder. The first interface surface may define a countersink surrounding the irrigation passage and the second interface surface may define a cylinder, and the cylinder may be insertable into the countersink. The countersink may be frusto-conical and the cylinder may be a conical cylinder. The irrigation guide may be rotatable relative to the first interface surface. The cutting tip may include a first diameter and the interface profile may include a first stepped section having a second diameter that is larger than the first diameter, and the first stepped section may be configured to form a countersink in the surgical template surrounding and in communication with the irrigation passage. The countersink may at least partially define the first interface surface.

The interface profile may include a second stepped section having a third diameter that is larger than the second diameter. The second stepped section may be configured to form a mating surface in the surgical template surrounding the countersink, and the first interface surface may include the mating surface. The second interface surface may fit within the first interface surface to secure the irrigation guide to the first interface surface. The irrigation channel may define an input axis and an output axis, and the input axis may be angled at least about 20 degrees relative to the output axis. In other configurations the input axis and the output axis may be substantially aligned.

The coupling end may include a length of rigid tubing in communication with the irrigation channel and having a distal end, and the distal end may include a retention feature for enhancing retention of the source of irrigation fluid to which the coupling end is coupleable. The irrigation guide may include an insertion end surrounding an exit of the irrigation channel and at least partially defining the second interface surface, and the insertion end may include a reduced diameter portion configured for insertion into a countersink defined by the first interface surface. The rigid tubing may extend through the irrigation guide from the coupling end to the second interface surface and may least partially define the irrigation channel.

The kit may also include a surgical template. The surgical template may include at least one anchoring feature adapted for engagement with a patient's anatomy to locate the surgical template, and a guide portion coupled to the anchoring feature and including a guide sleeve defining the guide chamber.

In other aspects, an implant osteotomy kit for dental implant placement in the mouth of a patient may be provided and the kit may include a surgical template including an anchoring feature adapted for engagement with the patient's anatomy, a guide portion coupled to the anchoring feature and defining a guide chamber, an irrigation passage fluidly communicating with the guide chamber, and a first interface surface surrounding the irrigation passage. The kit may also include an irrigation guide including a second interface surface, a coupling end, and an irrigation channel extending between the second interface surface and the coupling end. The second interface surface may be engageable with the first interface surface to secure the irrigation guide to the first interface surface and to place the irrigation channel into fluid communication with the guide chamber, and the coupling end may be couplable to a source of irrigation fluid for providing irrigation fluid to the guide chamber by way of the irrigation channel.

The first interface surface may define a cylinder surrounding the irrigation passage and the second interface surface may be tapered such that the second interface surface fits snugly within the cylinder when the second interface surface is inserted into the cylinder. The first interface surface may define a countersink surrounding the irrigation passage and the second interface surface may define a cylinder, and the cylinder may be insertable into the countersink. The countersink may be frusto-conical and the cylinder may be a conical cylinder. The first interface surface may include a mating surface surrounding the countersink. The second interface surface may fit within the first interface surface to secure the irrigation guide to the surgical template. The irrigation channel may define an input axis and an output axis, and the input axis may be angled at least about 20 degrees relative to the output axis. In other configurations the output axis and the input axis may be substantially aligned. The coupling end may include a length of rigid tubing in communication with the irrigation channel and having a distal end, and the distal end may include a retention feature for enhancing retention of the source of irrigation fluid to which the coupling end is couplable. The rigid tubing may extend through the irrigation guide from the coupling end to the second interface surface and may at least partially define the irrigation channel.

The irrigation guide may include an insertion end surrounding an exit of the irrigation channel and at least partially defining the second interface surface, and the insertion end may include a reduced diameter portion configured for insertion into a countersink defined by the first interface surface.

The kit may also include a drill bit including cutting tip, a shank, and an interface profile between the tip and the shank that may be configured to form the first interface surface on the surgical template.

The irrigation passage may define an irrigation axis, and when the second interface surface is engaged with the first interface surface the irrigation guide may be rotatable relative to the surgical template about the irrigation axis.

In other aspects, a method of irrigating an osteotomy site is provided and includes providing a surgical template including an anchoring feature adapted for engagement with the patient's anatomy, and a guide portion coupled to the anchoring feature and defining a guide chamber. The method also includes forming an irrigation passage fluidly communicating with the guide chamber, and a first interface surface surrounding the irrigation passage. The method also includes providing an irrigation guide including a second interface surface, a coupling end, and an irrigation channel extending between the second interface surface and the coupling end. The method also includes engaging the second interface surface with the first interface surface to secure the irrigation guide to the first interface surface and to place the irrigation channel into fluid communication with the guide chamber. The method also includes coupling the coupling end to a source of irrigation fluid to deliver irrigation fluid to the guide chamber via the irrigation channel.

The method may further include rotating the irrigation guide relative to the surgical template about an irrigation axis defined by the irrigation passage to locate the coupling end relative to the surgical template. The method may further include securing the second interface surface to the first interface surface with adhesive.

The method may further include providing a drill bit including a cutting tip, a shank, and an interface profile between the tip and the shank, and using the drill bit to form the irrigation passage and the first interface surface. After engaging the second interface surface with the first interface surface, an insertion end of the irrigation guide may extend through the surgical guide and into the guide chamber, and the method may further include grinding away a portion of the insertion end that is located within the guide chamber until an end of the insertion end is substantially flush with a wall of the guide chamber.

### BRIEF DESCRIPTION OF THE DRAWINGS

FIG. 1 is top view of in a dental implant surgical template with an irrigation guide attached thereto.

FIG. 2 is a section view taken along line 2-2 of FIG. 1.

FIG. 3 is an enlarged section view showing a first embodiment of an interface between the surgical template and irrigation guide of FIG. 1

FIG. 4 is an enlarged section view showing a second embodiment of an interface between the surgical template and irrigation guide of FIG. 1.

FIG. 5 is a plan view of a drill bit for forming an irrigation passage in the surgical template of FIG. 1.

FIG. 6 is a perspective view of the irrigation guide of FIG. 1

FIG. 7 is a perspective view of another embodiment of an irrigation guide.

FIG. 8 is an end view of the irrigation guide of FIG. 7.

FIG. 9 is a section view taken along line 9-9 of FIG. 7.

FIG. 10 is a side view of another embodiment of a drill bit for forming an irrigation passage.

FIG. 11 is a perspective view illustrating a first step of a method for providing irrigation to a dental implant osteotomy site.

FIG. 12 is a side view illustrating a second step of a method for providing irrigation to dental implant osteotomy site.

FIG. 13 is a perspective view illustrating a third step of a method for providing irrigation to a dental implant osteotomy site.

FIG. 14 is a perspective view illustrating a third step of a method for providing irrigation to a dental implant osteotomy site.

FIG. 15 is a perspective view illustrating a third step of a method for providing irrigation to a dental implant osteotomy site.

FIG. 16 is a perspective view illustrating a third step of a method for providing irrigation to a dental implant osteotomy site.

FIG. 17 is a perspective view illustrating a third step of a method for providing irrigation to a dental implant osteotomy site.

FIG. 18 is a perspective view of another embodiment of a dental implant surgical template with the irrigation guide of FIG. 7 attached thereto.

Before any embodiments of the invention are explained in detail, it is to be understood that the invention is not limited in its application to the details of construction and the arrangement of components set forth in the following description or illustrated in the accompanying drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

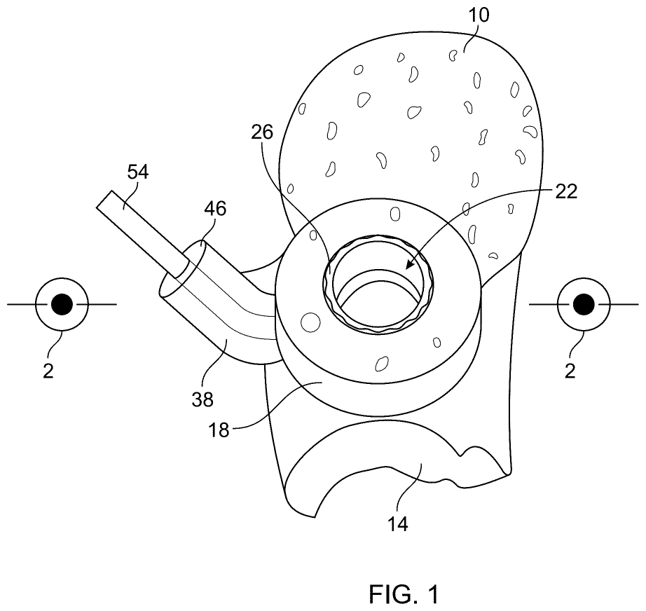

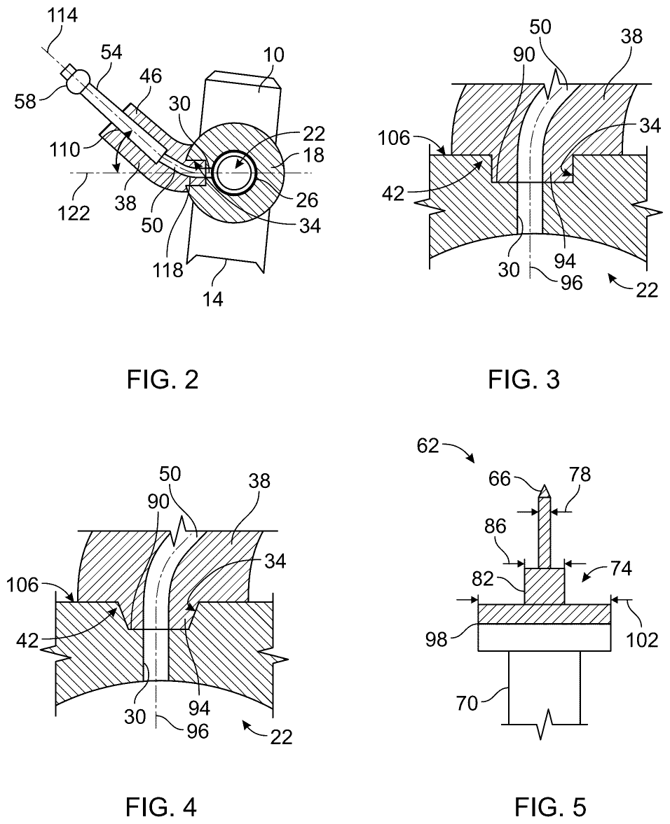

FIGS. 1 and 2 illustrate a surgical template 10 that functions as drilling guide during a dental implant procedure. The template 10 includes an anchoring feature 14 adapted for engagement with the patient's anatomy. A guide portion 18 is coupled to the anchoring feature and defines a guide chamber 22 adapted to receive a surgical drill (not shown). A metallic guide sleeve 26 may be inserted into the guide chamber 22 to protect the template 10 from the surgical drill during a drilling procedure. An irrigation passage 30 (FIG. 2) is formed in the guide portion 18 and fluidly communicates with the guide chamber 22. A first interface surface 34 (FIG. 2) is formed on the guide portion 18 and surrounds the irrigation passage 30.

Referring also to FIGS. 3 and 4, an irrigation guide 38 is attached to the guide portion of the template and includes a second interface surface 42, a coupling end 46, and an irrigation channel 50 extending between the second interface surface 42 and the coupling end 46. The second interface surface 42 is engageable with, and in some configurations may fit within, the first interface surface 34 to secure the irrigation guide 38 to the first interface surface 34 and to place the irrigation channel 50 into fluid communication with the irrigation passage 30. The coupling end 46 includes a length of rigid tubing 54 (e.g., stainless steel) inserted therein that communicates with the irrigation channel 50. The illustrated tubing 54 has a distal end that includes a retention feature 58, such as a barb, flare, luer lock, or the like, for enhancing retention of a source of irrigation fluid, such as surgical tubing connected to a source of saline (not shown) to the coupling end 46. In other configurations the retention feature may be eliminated and the outer diameter of the tubing 54 may be selected to provide a snug fit with the inner diameter of the source of irrigation fluid.

The surgical template 10 and the irrigation guide 38 may be provided together in common packaging to form an implant osteotomy kit for dental implant placement in the mouth of a patient.

Referring also to FIG. 5, in some configurations an alternative kit may be provided that includes the irrigation guide 38 and a drill bit 62 that can be used to form the irrigation passage 30 and the first interface surface 34 on the guide portion of a separately provided or obtained surgical template. The drill bit 62 includes a cutting tip 66, a shank 70, and an interface profile 74 between the tip 66 and the shank 70. In use, the tip 66 is configured to form the irrigation passage 30 in the guide portion 18 of the surgical template 10, while the interface profile 74 is configured to form the first interface surface 34. In still other configurations, a kit may be provided that includes the surgical template 10, the irrigation guide 38, and the drill bit 62. In this configuration the surgical template would not be provided with an irrigation passage 30 upon delivery, rather, the recipient of the kit would use the drill bit 62 as described herein to form the irrigation passage 30 at a location on the surgical template 10 of the user's choosing.

In the illustrated configuration of FIG. 5, the cutting tip 66 has a first diameter 78 and the interface profile 74 includes a first stepped section 82 having a second diameter 86 that is larger than the first diameter 78. The first stepped section is configured to form a countersink 90 (see FIGS. 3 and 4) in the surgical template 10 that surrounds and is in communication with the irrigation passage 30. As shown, the countersink 90 at least partially defines the first interface surface 34, and the second interface surface 42 defines an output end 94 that in the illustrated configuration is in the form of a reduced-diameter cylinder that is insertable into the countersink 90. The countersink 90 and cylindrical output end 94 configuration allow the irrigation guide 38 to be rotated relative to the first interface surface 34 of the template 10 about an irrigation axis 96 defined by the irrigation passage 30 to position the coupling end 46 in a desired orientation relative to the template 10. Once the coupling end 46 is positioned as desired adhesive or other securing methods may be used. As shown in FIGS. 3 and 4, the countersink 90 and the output end 94 can take on different shapes while performing the same function. By way of example, the countersink 90 may be frusto-conical and the output end 94 may be a conical cylinder, as shown in FIG. 4.

The interface profile 74 of the drill bit 62 may also include a second stepped section 98 having a third diameter 102 that is larger than the second diameter 86, wherein the second stepped section 98 is configured to form a mating surface 106 in the surgical template 10 surrounding the countersink 90. In some configurations the mating surface 106 forms part of the first interface surface 34.

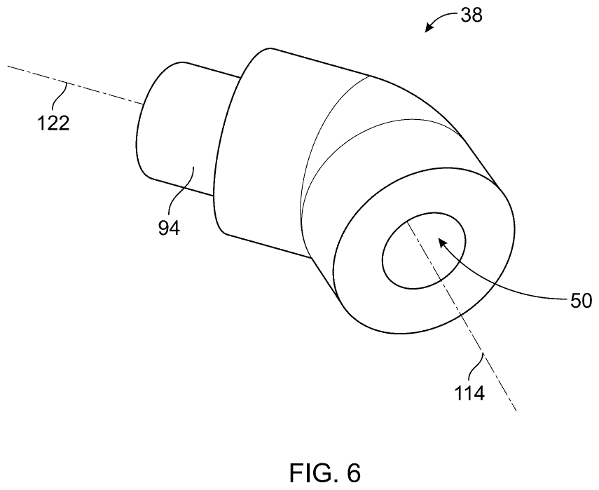

With reference also to FIG. 6, the irrigation channel 50 of the irrigation guide 38 defines an input axis 114 and an output axis 122, and the input axis 114 is angled at least about 20 degrees relative to the output axis 122. In other configurations, the input axis 114 and the output axis 122 may be substantially aligned.

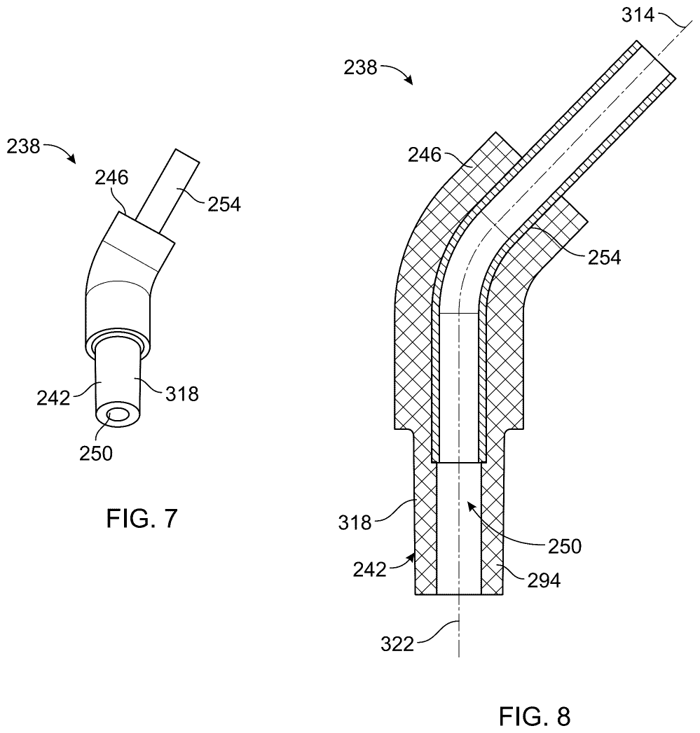

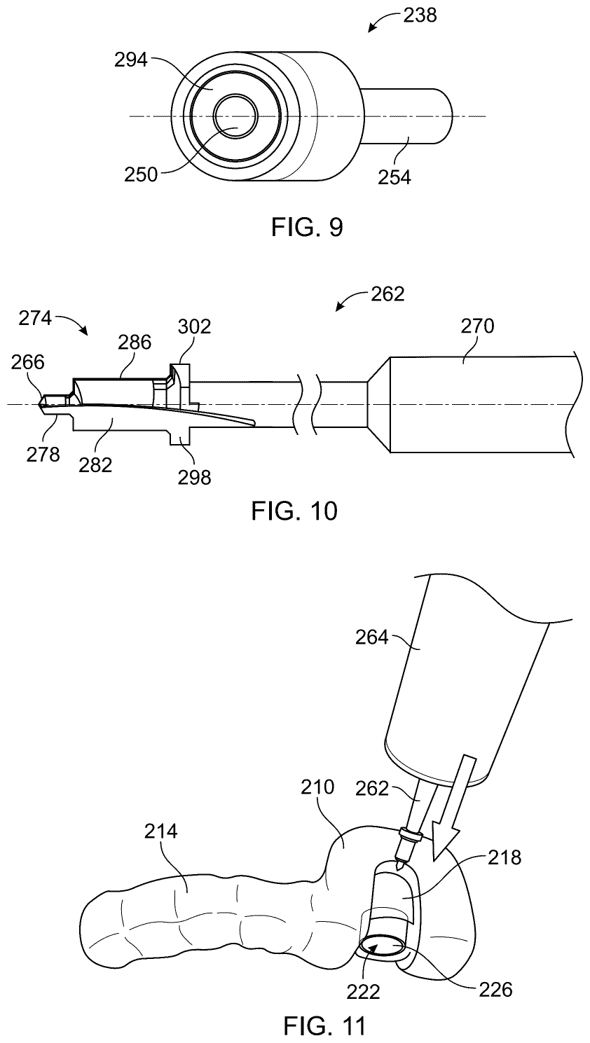

FIGS. 7-9 illustrate an alternative embodiment of an irrigation guide 238. The irrigation guide 238 includes an output end 318, a coupling end 246, and an irrigation channel 250 extending through the irrigation guide 238 and having an input end 310. The coupling end 246 includes a length of rigid tubing 254 (e.g., stainless steel) inserted therein that communicates with and, in the illustrated embodiment, partially defines the irrigation channel 250. In the embodiment of FIGS. 7-9 the tubing 254 extends from the coupling end 246, through the irrigation guide 238 to the output end 318, and at least partially defines the irrigation channel 250. In this way, the rigidity of the rigid tubing contributes to the overall strength of the irrigation guide 238. In some configurations the irrigation guide 238 may be formed by molding the body of the irrigation guide 238 over the tubing 254 using acrylic or other suitable material. Although not shown in FIGS. 7-9 the distal end of the tubing 254 may include a retention feature such as a barb, flare, luer lock, or the like for enhancing retention of a source of irrigation fluid.

The output end 318 of the irrigation guide 238 defines a second interface surface 242 that tapers slightly from its proximal end to its distal end, stated another way the second interface surface 242 has a conical cylindrical shape, for reasons discussed further below. The irrigation guide 238 also defines an input axis 314 and an output axis 322 that are angled at least 20 degrees relative to one another to facilitate positioning of the coupling end 246 within the patients mouth. In other configurations the input axis 314 and the output axis 322 maybe substantially aligned.

FIG. 10 illustrates an alterative embodiment of a drill bit 262 that may be used to form the irrigation passage 30, first interface surface 34, and mating surface 106. The drill bit 262 includes a cutting tip 266, a shank 270, and an interface profile 274 between the tip 266 and the shank 270. The cutting tip 266 has a first diameter 278 and the interface profile 274 includes a first stepped section 282 having a second diameter 286 that is larger than the first diameter 278. The drill bit 262 may also include a second stepped section 298 having a third diameter 302 that is larger than the second diameter 286. The dimensions and configuration of the drill bit 262 are configured to cooperate with the dimensions and configuration of the irrigation guide 238. In this regard it is contemplated that the drill bit 262 and the irrigation guide 238 may be provided as a kit that may be used by a health care professional to form an irrigation passage 30 in a surgical template 10 that is configured to receive the irrigation guide 238 for irrigating a dental implant osteotomy site or for providing irrigation in a similar way to substantially irrigate and control heat generation of any surgical site where the site may be surrounded or enclosed by a rigid template or covering that is configured to guide or otherwise assist in an osteotomy procedure.

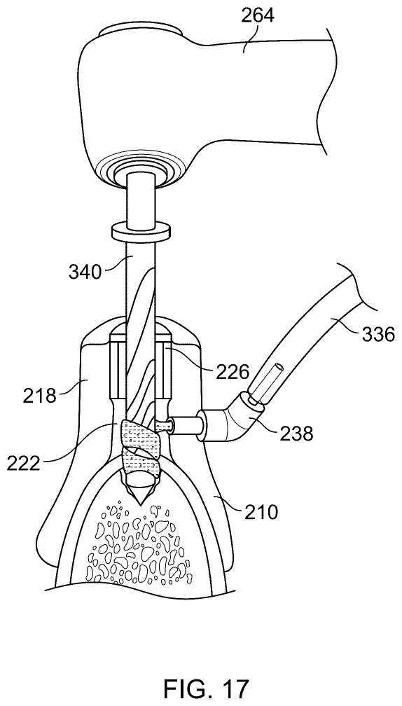

FIGS. 11-17 illustrate a method of irrigating a dental implant osteotomy site. As shown in FIG. 11, the method includes providing a surgical template 210 including an anchoring feature 214 adapted for engagement with the patient's anatomy, and a guide portion 218 coupled to the anchoring feature 214 and defining a guide chamber 222. The guide chamber 222 may be provided with a guide sleeve 226, which may be made of metal or another durable material, to assist in guidance of the osteotomy drill bit during an osteotomy procedure as discussed further below. The drill bit 262 is attached to a rotary drill 264 and is moved toward the guide portion 218 in the direction of the arrow in FIG. 11. While the exact location of the irrigation passage 30 to be formed will vary depending on the specific application, it is generally preferred for the irrigation passage to be positioned on the guide portion between the patient's anatomy and the guide sleeve 226.

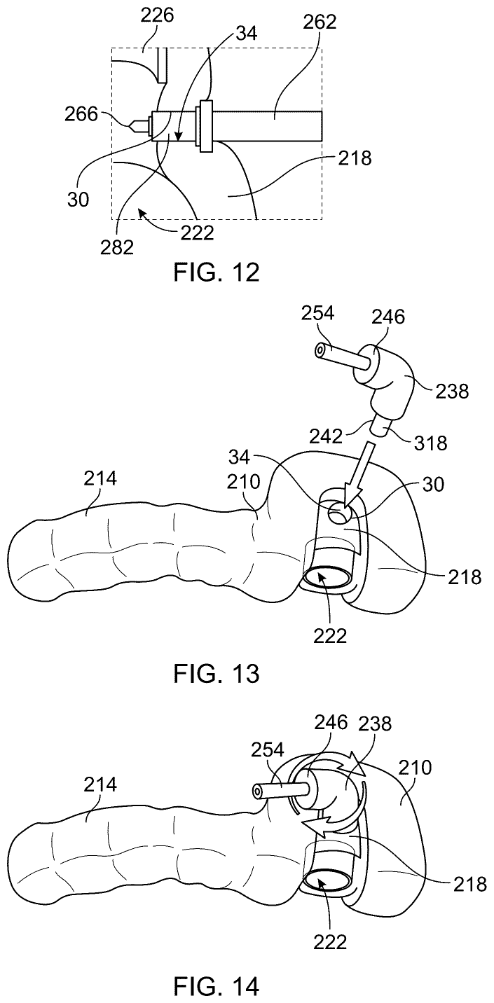

As shown in FIG. 12, the method includes using the drill bit 262 to form an irrigation passage 30 that fluidly communicates with the guide chamber 222, and a first interface surface 34 that surrounds the irrigation passage 30. In the illustrated example of FIG. 12, the thickness of the guide portion 218 is such that both the cutting tip 266 and the first stepped section 282 have passed all the way through the guide portion 218. The resulting irrigation passage 30 will therefore have a diameter that corresponds to the second diameter 286 of the drill bit 262. In other applications the thickness of the guide portion 218 may be such that only the cutting tip 266 passes all the way through the guide portion 218 resulting in an irrigation passage 30 that corresponds to the first diameter 278 surrounded by a countersink that corresponds to the second diameter 286, as shown, for example, in FIGS. 3 and 4.

As shown in FIG. 13, with the irrigation passage 30 formed in the guide portion 218 the irrigation guide 238 may be provided and the output end 318 thereof may be inserted into the irrigation passage 30 such that the second interface surface 242 is engaged with the first interface surface 34. The tapered configuration of the output end 318 allows the output end 318 to be inserted into the irrigation passage 30 until a snug but adjustable fit is achieved. With the output end 318 inserted into the irrigation passage the irrigation channel 250 of the irrigation guide 238 is placed into fluid communication with the irrigation passage 30 and the guide chamber 222 of the surgical template 210.

As shown in FIG. 14, the configuration of and interaction between the output end 318 and the first interface surface 34 is such that the irrigation guide 238 may be rotated relative to the surgical template 210 about the axis of the irrigation passage 30 to locate the coupling end 246 and the tubing 254 in a desired orientation relative to the surgical template 210, for example to facilitate easier routing of a source of irrigating fluid within the patient's mouth, or to avoid interference with implant drills or guide keys. Once the desired orientation is achieved, the location of the irrigation guide 238 and second interface surface 242 may be fixed relative to the surgical template 210 and the first interface surface 234 by applying a small amount of adhesive, for example cyanoacrylate, to the interface between the irrigation guide 238 and the surgical template 210. In other configurations the surgical template 210 and irrigation guide may be coupled or secured to one another using other methods of mechanical connection such as mechanical lock, twist lock, snap lock, or magnetic lock configurations, for example.

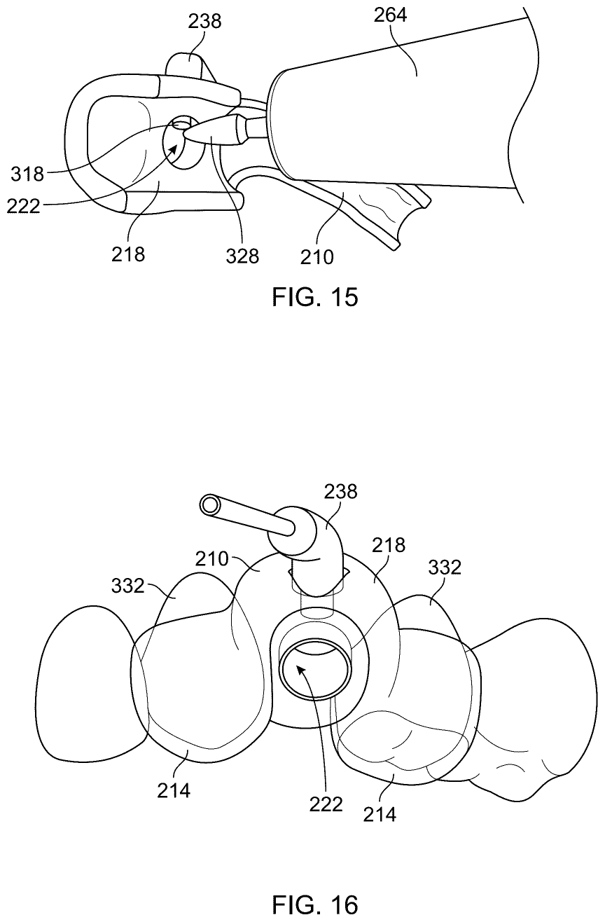

As shown in FIG. 15, in some applications, the length of the output end 318 may be greater than the thickness of the guide portion 218 such that the end of the output end 318 extends into the guide chamber 222. In such instances, to provide adequate clearance for the osteotomy drill bit, a burr 328 or similar attachment may be used in cooperation with the drill 264 to grind away the portion of the output end 318 that extends into the guide chamber 222 until the end of the output end 318 is substantially flush with the wall of the guide chamber 222.

With the output end 318 flush with the guide chamber and the irrigation guide 238 secured to the surgical template 210, as shown in FIG. 16 the surgical template may be positioned over the osteotomy site by securing the anchoring features 214 to the patient's anatomy, which in the illustrated example includes teeth 332 on either side of the osteotomy site. With the osteotomy site prepared and the surgical template 210 secured to the patient's anatomy, a source of irrigation fluid 336, such as surgical tubing connected to a source of saline, may be connected to the coupling end 246 of the irrigation guide 238, for example by positioning the tubing over surgical tubing over the rigid tubing 254. When irrigation fluid is supplied to the coupling end 246 of the irrigation guide 238 it flows through the irrigation channel 250, through the output end 318, and into the guide chamber 222 where it flows around and cools the osteotomy site while also flushing away drill debris such as bone particles. An osteotomy drill bit 340 is attached to the drill 264 and inserted through the guide sleeve 226 and into the guide chamber 222. The drill bit 340 may then be manipulated to perform the osteotomy procedure while being cooled with the irrigation fluid 336 provided to the guide chamber 222 by the irrigation guide 238.

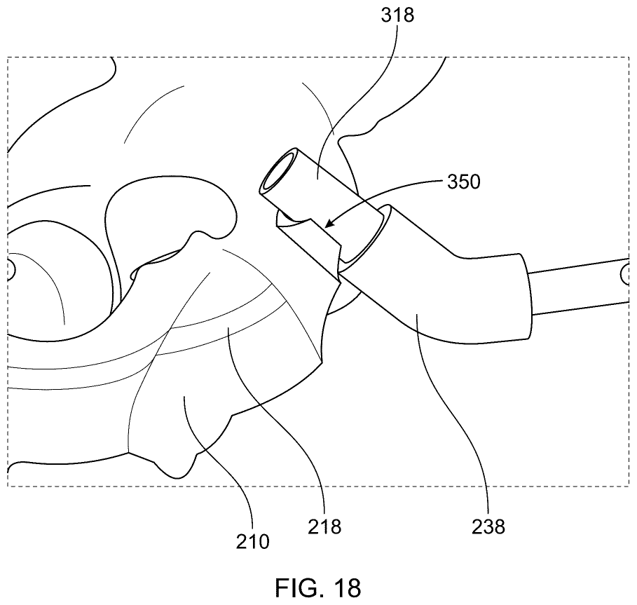

Referring to FIG. 18, in some applications, the surgical template 210 may be configured with a guide portion 218 that does not extend to fully cover or enclose the patient's anatomy, in which case there may be a gap or space between the patient's anatomy and the surgical template 210 and there may not be enough material in the guide portion 218 to form an irrigation passage 30 in the form of a cylindrical hole. In such applications, the drill bit 262 may be manipulated not in an axial direction, but in a lateral direction to form a depression or recess 350 in the surgical template 210 and oriented generally toward the osteotomy site. The output end 318 of the irrigation guide 238 may then be attached to the recess 350 using adhesive such that irrigation fluid flowing through the irrigation guide 238 is directed toward the osteotomy site.

Various features of the invention are set forth in the following claims.

What is claimed is:

1. A kit for irrigating a dental implant surgical template, the surgical template including a guide chamber adapted to receive a surgical drill, the kit comprising:
a drill bit including a cutting tip, a shank, and an interface profile between the tip and the shank, the tip configured to form an irrigation passage in the surgical template that communicates with the guide chamber, and the interface profile configured to form a first interface surface on the surgical template; and
an irrigation guide including a second interface surface, a coupling end, and an irrigation channel extending between the second interface surface and the coupling end, wherein the second interface surface is engageable with the first interface surface to secure the irrigation guide to the first interface surface and to place the irrigation channel into fluid communication with the guide chamber, and wherein the coupling end is coupleable to a source of irrigation fluid for providing irrigation fluid to the irrigation channel and the guide chamber.

2. The kit of claim 1, wherein the second interface surface fits within the first interface surface to secure the irrigation guide to the first interface surface.

3. The kit of claim 2, wherein the first interface surface defines a cylinder and the second interface surface is tapered such that the second interface surface fits snugly within the cylinder when the second interface surface is inserted into the cylinder.

4. The kit of claim 1, wherein the irrigation channel defines an input axis and an output axis, and wherein the input axis is angled at least 20 degrees relative to the output axis.

5. The kit of claim 4, wherein when the second interface surface is engaged with the first interface surface the irrigation guide is rotatable relative to the surgical template about the output axis.

6. The kit of claim 1, wherein the coupling end includes a length of rigid tubing in communication with the irrigation channel and having a distal end, and wherein the distal end includes a retention feature.

7. The kit of claim 6, wherein the rigid tubing extends through the irrigation guide from the coupling end to the second interface surface and at least partially defines the irrigation channel.

8. The kit of claim 1, further comprising the surgical template, the surgical template including at least one anchoring feature adapted for engagement with a patient's anatomy to locate the surgical template, and a guide portion coupled to the anchoring feature and including a guide sleeve at least partially defining the guide chamber.

9. An implant osteotomy kit for dental implant placement in the mouth of a patient, the kit comprising:
a surgical template including an anchoring feature adapted for engagement with the patient's anatomy, a guide portion coupled to the anchoring feature and defining a guide chamber, an irrigation passage fluidly communicating with the guide chamber, and a first interface surface surrounding the irrigation passage; and
an irrigation guide including a second interface surface, a coupling end, and an irrigation channel extending between the second interface surface and the coupling end, wherein the second interface surface is engageable with the first interface surface to secure the irrigation guide to the first interface surface and to place the irrigation channel into fluid communication with the guide chamber, and wherein the coupling end is coupleable to a source of irrigation fluid for providing irrigation fluid to the guide chamber by way of the irrigation channel.

10. The kit of claim 9, wherein the first interface surface defines a cylinder surrounding the irrigation passage and the second interface surface is tapered such that the second interface surface fits snugly within the cylinder when the second interface surface is inserted into the cylinder.

11. The kit of claim 9, wherein the irrigation channel defines an input axis and an output axis, and wherein the input axis is angled at least about 20 degrees relative to the output axis.

12. The kit of claim 11, wherein when the second interface surface is engaged with the first interface surface the irrigation guide is rotatable relative to the surgical template about the output axis.

13. The kit of claim 9, further comprising a drill bit including cutting tip, a shank, and an interface profile between the tip and the shank and configured to form the first interface surface on the surgical template.

14. The kit of claim 9, wherein the coupling end includes a length of rigid tubing extending therefrom, and wherein the rigid tubing further extends through the irrigation guide from the coupling end to the second interface surface and at least partially defines the irrigation channel.

15. A method of irrigating an osteotomy site, the method comprising:
providing a surgical template including an anchoring feature adapted for engagement with the patient's anatomy, and a guide portion coupled to the anchoring feature and defining a guide chamber;
forming an irrigation passage fluidly communicating with the guide chamber, and a first interface surface surrounding the irrigation passage;
providing an irrigation guide including a second interface surface, a coupling end, and an irrigation channel extending between the second interface surface and the coupling end;
engaging the second interface surface with the first interface surface to secure the irrigation guide to the first interface surface and to place the irrigation channel into fluid communication with the guide chamber; and
coupling the coupling end to a source of irrigation fluid to deliver irrigation fluid to the guide chamber via the irrigation channel.

16. The method of claim 15, further comprising rotating the irrigation guide relative to the surgical template to locate the coupling end relative to the surgical template.

17. The method of claim 15, further comprising securing the irrigation guide to the surgical template with adhesive.

18. The method of claim 15, further comprising providing a drill bit including a cutting tip, a shank, and an interface profile between the tip and the shank.

19. The method of claim 18, further comprising using the drill bit to form the irrigation passage and the first interface surface.

20. The method of claim 15, wherein after engaging the second interface surface with the first interface surface an output end of the irrigation guide extends through the surgical guide and into the guide chamber, the method further comprising grinding away a portion of the output end that is located within the guide chamber until an end of the output end is substantially flush with a wall of the guide chamber.
